(19) United States
(12) Patent Application Publication
(10) Pub. No.: US 2023/0007094 A1
(43) Pub. Date: Jan. 5, 2023

(54) Method, Device, Computer Program and Computer-Readable Storage Medium for Operating a Vehicle

(71) Applicant: Bayerische Motoren Werke Aktiengesellschaft, Muenchen (DE)

(72) Inventor: Johannes Mueller, Unterschleissheim (DE)

(21) Appl. No.: 17/781,355

(22) PCT Filed: Jan. 19, 2021
(86) PCT No.: PCT/EP2021/050993

§ 371 Date: May 31, 2022

(30) Foreign Application Priority Data
Mar. 9, 2020 (DE) 10 2020 106 266.4

(51) Int. Cl. H04L 67/306; B60R 16/037

(52) U.S. Cl. CPC H04L 67/306; B60R 16/037

(57) ABSTRACT

A method includes capturing first and second personal information representative of first and second occupants of the vehicle. The method also includes providing vehicle information which is representative of vehicle functions and dependencies therebetween. If first request information from the first occupant for a first vehicle function, and second request information from the second occupant for a second vehicle function are captured, then, based at least partly on the vehicle information, the first request information and the second request information, it is ascertained whether the first and second requests have a correlation such that prioritization should take place with regard to execution of the first and second vehicle functions. If the correlation exists, then first proposal information is ascertained representing a way in which priority is to be given with regard to the execution of the first and second vehicle functions. The vehicle functions are executed accordingly.

The present application is the U.S. national phase of PCT Application PCT/EP2021/050993 filed on Jan. 19, 2021 which claims priority of German patent application No. 102020106266.4 filed on Mar. 9, 2020, which is incorporated herein by reference in its entirety.

### TECHNICAL FIELD

The disclosure relates to a method for operating a vehicle. The disclosure also relates to a device, a computer program, and a computer-readable storage medium for operating a vehicle.

### BACKGROUND

A vehicle can detect a request by a passenger to execute a vehicle function.

One of the objects of this disclosure is to create a method that contributes to the comfortable and safe operation of a vehicle in traffic. In addition, a corresponding device, a corresponding computer program and computer-readable storage medium shall be created.

### SUMMARY

The object is achieved by the features of the one or more embodiments described herein.

A first aspect is characterized by a method for operating a vehicle.

In accordance with the first aspect, first personal information is captured. The first personal information is representative of a first occupant of the vehicle. Second personal information is captured. The second personal information is representative of a second occupant of the vehicle. Vehicle information is provided. The vehicle information is representative of a specified set of vehicle functions and dependencies between the vehicle functions that exist when they are executed. If first request information, which is representative of a first request by the first occupant for a first vehicle function from the predefined set of vehicle functions, and second request information, which is representative of a second request by the second occupant for a second vehicle function from the predefined set of vehicle functions, are captured, the vehicle information, the first request information and the second request information are used as a basis for ascertaining whether the first request for the first vehicle function and the second request for the second vehicle function have a correlation, such that prioritization should take place with regard to execution of the first vehicle function and execution of the second vehicle function. If such a correlation exists, the first personal information and the second personal information are used as a basis for ascertaining first proposal information. The first proposal information is representative of the way in which the priority is to be given with regard to the execution of the first vehicle function and the execution of the second vehicle function. Depending on the first proposal information, the first vehicle function and/or the second vehicle function is or are executed for operating the vehicle.

The method according to the first aspect makes it possible to provide a procedure for executing the first vehicle function and executing the second vehicle function in the event of such a correlation. This is particularly advantageous if the first request for the first vehicle function and the second request for the second vehicle function show such a correlation. Such a correlation can also be described in terms of a competition or conflict caused between the first occupant's request and the second occupant's request. The method according to the second aspect can be used to ascertain the first proposal information which is representative of one or more possible solutions to the conflict. For example, this can reduce the potential for conflict between the first occupant and the second occupant and allow for comfortable driving. As a result, this can enable safe operation of the vehicle in traffic.

The vehicle can be any vehicle, such as a vehicle with a battery-powered electric drive and/or a vehicle with an internal combustion engine and/or a so-called hybrid vehicle and/or a vehicle that can be operated partially or fully automatically, or similar.

The first personal information and/or the second personal information is captured depending on one or more sensors of the vehicle, which are appropriately designed. The one or more sensors comprise, for example, a microphone and/or a camera, such as a camera for monitoring an interior of the vehicle and/or a camera for monitoring an exterior of the vehicle or similar, and/or a sensor for detecting an access authorization device (so-called “ID sensor”) of the first occupant and/or the second occupant, for example, a vehicle key that can be assigned to the first occupant and/or the second occupant, or similar.

The first personal information can comprise a first item of characteristic information about the first occupant. The first characteristic information item is representative of one or more of the following characteristics or preferences of the first occupant: for example, an age of the first occupant and/or an age group of the first occupant, such as “old” or “young”, and/or a personal class of the first occupant, such as “adult” and/or “child” and/or “chauffeur” and/or “passenger” and/or “driver” and/or “front-seat passenger” or similar, and/or a gender of the first occupant, or similar.

The second personal information can comprise a second item of characteristic information about the second occupant, wherein the second characteristic information item can have the same features as the first characteristic information.

For example, part of the first personal information and/or part of the second personal information may already be stored in a data memory of the vehicle.

Additionally or alternatively, another part of the first personal information and/or another part of the second personal information may be stored on a server located externally to the vehicle and made available to the vehicle by this server. For example, the vehicle and the server have corresponding communication interfaces. The server can be part of a backend (server) and/or cloud or similar. This means that the remaining part of the first personal information and/or the remaining part of the second personal information can be provided based on a mobile terminal of the first occupant and/or a mobile terminal of the second occupant. For example, the first occupant's mobile device and/or the second occupant's mobile device is or are each representative of a mobile phone and/or a smartphone and/or tablet computer and/or a computer or similar. The other part of the first personal information and/or the other part of the second personal information is or are ascertained, for example, by the corresponding mobile terminal device based on an application or application software (so-called “app”) that is installed or available on the corresponding mobile terminal.

The vehicle information can be stored in the data memory of the vehicle. Additionally or alternatively, the vehicle information is acquired based on one or more sensors of the vehicle, which are appropriately designed. For example, the one or more sensors include the microphone and/or the camera. The specified set of vehicle functions is ascertained, for example, depending on the equipment features of the vehicle. The vehicle's equipment features can be any equipment features, such as controls and/or interior and/or exterior elements. For example, the vehicle's equipment features include one or more of the following: a vehicle type, such as a “saloon” or similar, and/or a vehicle display device and/or a vehicle air conditioning system and/or a vehicle heating system and/or a vehicle seat and/or a vehicle seat heater, and/or a vehicle lighting device and/or a vehicle entertainment system (so-called “infotainment system”) and/or a loudspeaker in the vehicle and/or an application installed in the vehicle and/or a digital service of the vehicle and/or a menu or menu navigation system that is displayed on the vehicle display device or similar. For example, a digital service may be a service designed to play a music request depending on the loudspeaker and/or to determine a route to a point of interest (PoI) and/or to book appointments.

For example, the vehicle information comprises spatial assignments of the vehicle functions within the vehicle, such as a first seat heater being assigned to a first seat and a second seat heater being assigned to a second seat and/or a first display device being assigned to the first seat and a second display device being assigned to the second seat.

Any particular vehicle function from the set of vehicle functions can be executed in connection with one or more equipment features. For example, the specified set of vehicle functions comprises one or more of the following: a vehicle function for controlling the seat heater and/or a vehicle function for controlling the air conditioning system and/or a vehicle function for controlling the lighting device and/or a vehicle function for controlling the heating system and/or a vehicle function for controlling the entertainment system, or similar.

The dependencies between the vehicle functions that exist during their execution are representative, for example, of which of the vehicle functions can be executed dependent on or independently of each other.

The first request information and/or the second request information is or are captured depending on one or more sensors of the vehicle which are appropriately designed. The one or more sensors comprise, for example, the microphone and/or camera and/or an input device of the vehicle.

The first request can include activation and/or deactivation and/or adaptation of the first vehicle function.

The second request can include activation and/or deactivation and/or adaptation of the second vehicle function.

The first request information can also be representative of multiple first requests of the first occupant regarding multiple first vehicle functions.

The second request information can also be representative of multiple second requests of the second occupant regarding multiple second vehicle functions.

For example, the first request can be representative of the first occupant wanting to set a temperature to a first specified value in a region of the first seat. For example, the second request can be representative of the second occupant wanting to set a temperature to a second specified value in a region of the second seat.

The first vehicle function and the second vehicle function can be different vehicle functions or the same vehicle function.

For example, a dependency is determined between the first vehicle function and the second vehicle function depending on the vehicle function.

For example, the first request for the first vehicle function and the second request for the second vehicle function will have such a correlation whenever the execution of the first vehicle function and the execution of the second vehicle function are not possible, or only to a limited extent, for example due to the dependency between the first vehicle function and the second vehicle function. This can be the case, for example, if it is ascertained based on the first set temperature and the second set temperature that a temperature gradient would be above a specified threshold. For example, the vehicle information includes the specified threshold.

For example, the first request for the first vehicle function and the second request for the second vehicle function will have no such correlation if the execution of the first vehicle function and the execution of the second vehicle function are possible. This can be the case, for example, if it is ascertained based on the first set temperature and the second set temperature that the temperature gradient would not exceed the specified threshold value.

For example, the first request information is ascertained at a first time point or in a first time interval. For example, the second request information is ascertained at a second time point or in a second time interval. For example, at the second time point, execution of the first vehicle function for the first request is not yet completed.

The first proposal information may comprise one or more proposals, each of which is representative of a particular way of prioritizing the execution of the first vehicle function relative to the execution of the second vehicle function.

For example, a particular proposal comprises a weighting figure that is representative of how suitable the particular intended prioritization method is for enabling a traffic-safe and/or comfortable operation of the vehicle with respect to the first occupant and/or the second occupant. For example, the vehicle can automatically execute the first vehicle function and/or the second vehicle function for operating the vehicle, depending on the first proposal information. For example, this is achieved according to a proposal that has the highest weighting figure.

The prioritization to be used with regard to the execution of the first vehicle function and the execution of the second vehicle function can be carried out, for example, in such a way that the first vehicle function and the second vehicle function are executed consecutively. Alternatively, only the first vehicle function may be executed. Alternatively, only the second vehicle function may be executed. Alternatively, the execution of the first vehicle function can be started first and the execution of the second vehicle function may in some cases be started during the execution of the first vehicle function, temporally overlapping it.

The method according to the first aspect and its optional embodiments can also be extended accordingly to multiple first occupants or multiple second occupants.

In accordance with an optional embodiment of the first aspect, the first personal information includes first personal prioritization information. The first personal prioritization information is representative of a prioritization of the first occupant. Additionally or alternatively, the second personal information includes second personal prioritization information. The second personal prioritization information is representative of a prioritization of the second occupant.

This makes it possible to prioritize the first occupant and/or the second occupant. This is advantageous, for example, if a personal class of the first occupant differs from a personal class of the second occupant. This allows different vehicle occupants to be prioritized differently.

The prioritization of the first occupant and/or the prioritization of the second occupant can take place, for example, in the context of determining the proposal information.

For example, the other part of the first personal information provided by the external server includes the first personal prioritization information.

For example, the other part of the second personal information provided by the external server includes the second personal prioritization information.

This means that the first prioritization information and/or the second prioritization information can be provided based on a mobile terminal of the first occupant and/or the mobile terminal of the second occupant.

For example, the vehicle comprises a digital voice assistant which is designed to interact with the first occupant and/or the second occupant depending on the input device of the vehicle and/or an output device of the vehicle. For example, the output device comprises the display device of the vehicle and/or the loudspeaker of the vehicle, or similar.

For example, the first prioritization information and/or the second prioritization information can be specified depending on the input device and/or the digital voice assistant and/or the menu navigation system and/or the microphone.

In accordance with a further optional embodiment of the first aspect, the first proposal information is provided to the first occupant and/or the second occupant. A first user input of the first occupant and/or the second occupant is captured. Depending on the first user input, the first vehicle function and/or the second vehicle function is or are executed for operating the vehicle.

This makes it possible for the first occupant and/or the second occupant to select one of the proposals of the first proposal information.

For example, the first proposal information is provided to the first occupant and/or the second occupant depending on the digital voice assistant and/or the output device.

The first user input is captured depending on one or more sensors of the vehicle, which are appropriately designed. The one or more sensors comprise, for example, the microphone and/or the camera and/or the input device of the vehicle.

Multiple first user inputs can also be captured. For example, a first user input by the first occupant is captured and a further first user input by the second occupant.

In accordance with a further optional embodiment of the first aspect, the first vehicle function and/or the second vehicle function is or are executed for operating the vehicle depending on the first personal information and/or the second personal information.

This makes it possible, in particular in case multiple first user inputs are captured, to prioritize one of the corresponding user inputs depending on the first personal information and/or the second personal information.

For example, it is ascertained that the first occupant should be prioritized over the second occupant depending on the first personal prioritization information and/or the second personal prioritization information. In this case, the first vehicle function and/or the second vehicle function is or are executed for operating the vehicle depending on the first user input of the first occupant.

Alternatively, it is ascertained that the second occupant should be prioritized over the first occupant depending on the first personal prioritization information and/or the second personal prioritization information. In this case, the first vehicle function and/or the second vehicle function is or are executed for operating the vehicle depending on the additional first user input of the first occupant, in particular according to the prioritization of the respective occupants.

In accordance with a further optional embodiment of the first aspect, the first personal information is representative of a first spatial assignment of the first occupant within the vehicle. Additionally or alternatively, the first personal information includes a first user history of the first occupant. Additionally or alternatively, the second personal information is representative of a second spatial assignment of the second occupant within the vehicle. In addition or alternatively, the second personal information includes the second user history of the second occupant.

The first spatial assignment is captured depending on one or more sensors of the vehicle, which are appropriately designed. The one or more sensors comprise, for example, the vehicle's camera. The first spatial assignment is representative of a first position where the first occupant is located in the vehicle. In particular, the first spatial assignment can be representative of whether the first occupant is occupying a driver's seat of the vehicle or a front passenger seat of the vehicle or another passenger seat of the vehicle or a rear seat of the vehicle.

The first spatial assignment of the first occupant within the vehicle makes it possible to ascertain the first proposal information efficiently. It can also be used, for example, to ascertain the personal class of the first occupant. The second spatial assignment is captured depending on one or more sensors of the vehicle, which are appropriately designed. The one or more sensors comprise, for example, the vehicle's camera. The second spatial assignment is representative of a second position where the second occupant is located in the vehicle. In particular, the second spatial assignment can be representative of whether the second occupant is occupying a driver's seat of the vehicle or a front passenger seat of the vehicle or another passenger seat of the vehicle or a rear seat of the vehicle.

The second spatial assignment of the second occupant within the vehicle makes it possible to ascertain the first proposal information efficiently. It can also be used, for example, to ascertain the personal class of the second occupant.

The first user history of the first occupant comprises, for example, a personalized customer profile and/or a collection of information relating to the first occupant, which was provided, in particular, before carrying out the method in accordance with the first aspect. For example, the additional part of the first personal information provided by the external server includes the first user history.

The first user history of the first occupant makes it possible to ascertain the first proposal information efficiently.

The second user history of the second occupant comprises, for example, a personalized customer profile and/or a collection of information relating to the second occupant, which was provided, in particular, before carrying out the method in accordance with the first aspect. For example, the additional part of the second personal information provided by the external server includes the second user history.

The second user history of the first occupant makes it possible to ascertain the first proposal information efficiently.

According to a further optional embodiment of the first aspect, if no such correlation exists, second proposal information is determined depending on the first personal information and the second personal information. The second proposal information is representative of the way in which the first vehicle function and the second vehicle function should be carried out. The first vehicle function and the second vehicle function are executed for operating the vehicle depending on the second proposal information.

This makes it possible to automatically provide a procedure for executing the first vehicle function and executing the second vehicle function if no such correlation exists. This case can also be described in terms of there being no competition or conflict between the first occupant's request and the second occupant's request. For example, this can enable comfortable driving.

The second proposal information can comprise one or more proposals, each of which is representative of a particular way of prioritizing the execution of the first vehicle function relative to the execution of the second vehicle function. For example, a particular proposal comprises a weighting figure that is representative of how suitable the particular method is for enabling a traffic-safe and/or comfortable operation of the vehicle.

For example, the vehicle can automatically execute the first vehicle function and the second vehicle function for operating the vehicle, depending on the second proposal information. For example, this is achieved according to a proposal that has the highest weighting figure.

If the first vehicle function and the second vehicle function are to be executed, this can be carried out, for example, in such a way that the first vehicle function and the second vehicle function are executed simultaneously. Alternatively, the execution of the first vehicle function can be started first and the execution of the second vehicle function may in some cases be started during the execution of the first vehicle function, temporally overlapping it.

In accordance with a further optional embodiment of the first aspect, the second proposal information is provided to the first occupant and/or the second occupant. A second user input of the first occupant and/or the second occupant is captured. The first vehicle function and the second vehicle function are executed for operating the vehicle depending on the second user input.

This makes it possible for the first occupant and/or the second occupant to select one of the proposals of the second proposal information.

For example, the second proposal information is provided to the first occupant and/or the second occupant depending on the digital voice assistant and/or the output device.

The second user input is captured depending on one or more sensors of the vehicle, which are appropriately designed. The one or more sensors comprise, for example, the microphone and/or the camera and/or the input device of the vehicle.

Multiple second user inputs can also be captured. For example, a second user input by the first occupant is captured and a further second user input by the second occupant.

In accordance with a further optional embodiment of the first aspect, the first vehicle function and/or the second vehicle function is or are executed for operating the vehicle depending on the first personal information and/or the second personal information.

This makes it possible, in particular in case multiple second user inputs are captured, to prioritize one of the corresponding user inputs depending on the first personal information and/or the second personal information. For example, it is ascertained that the first occupant should be prioritized over the second occupant depending on the first personal prioritization information and/or the second personal prioritization information. In this case, the first vehicle function and the second vehicle function is or are executed for operating the vehicle depending on the first user input by the first occupant.

Alternatively, depending on the first personal prioritization information and/or the second personal prioritization information, it is ascertained that the second occupant should be prioritized over the first occupant. In this case, the first vehicle function and the second vehicle function is or are executed for operating the vehicle depending on the additional first user input by the first occupant.

The method according to the first aspect and its optional embodiments can be extended accordingly for any number of occupants of the vehicle. For example, for each additional occupant, a corresponding additional personal information item, a corresponding additional request information item is captured or ascertained, each of which can have similar characteristics to the first personal information and/or the second personal information or the first request information and/or the second request information. The determination of whether such a correlation exists, the determination of the first proposal information and/or the second proposal information, the first user input and/or the second user input, and the execution of the first vehicle function and/or the execution of the second vehicle function, can also be extended accordingly for each additional occupant.

A second aspect is characterized by a device for operating a vehicle. The device is designed to carry out the method for operating a vehicle according to the first aspect.

The device can be embodied in one component or divided over a plurality of components.

A third aspect is characterized by a computer program, wherein the computer program comprises instructions which, when the computer program is executed by a computer, cause the computer to carry out the method for operating a vehicle according to the first aspect.

A fourth aspect is characterized by a computer-readable storage medium on which the computer program according to the third aspect is stored.

Optional embodiments of the first aspect may also be present in the other aspects accordingly and have corresponding effects.

### BRIEF DESCRIPTION OF THE DRAWINGS

Exemplary embodiments are described in more detail below by reference to the schematic drawings. In the drawings:

FIG. 1 shows a schematic drawing of a distributed system, and

FIG. 2 shows a flowchart of a program for operating a vehicle.

### DETAILED DESCRIPTION

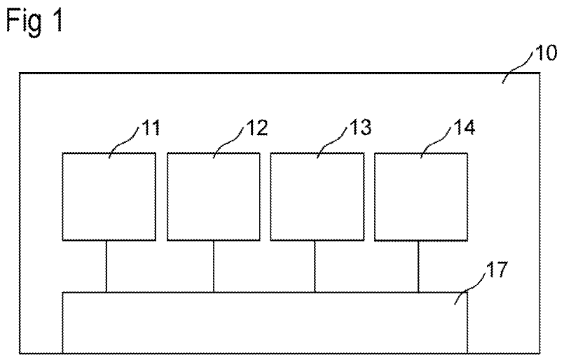

FIG. 1 shows a schematic drawing of a distributed system. The distributed system comprises a vehicle 10. The vehicle 10 comprises an input device 11. In addition, the vehicle 10 comprises a microphone 12. In addition, the vehicle 10 comprises a camera 13. In addition, the vehicle 10 comprises an output device 14. In addition, the vehicle 10 comprises a device 17 for operating the vehicle 10.

Depending on the input device 11, first request information and/or second request information and/or a first user input (ENI) and/or a second user input (ZNI) can be captured.

For example, the input device 11 comprises a touch-sensitive display device (so-called “touch display”) of the vehicle 10 and/or a control element of the vehicle 10 or similar.

Depending on the microphone 12, first personal information (EPI) and/or second personal information (ZPI) and/or the first request information and/or the second request information and/or the first user input (ENI) and/or the second user input (ZNI) can be captured, for example, depending on an audio signal, captured by the microphone 12, that is representative of a voice of a first occupant of the vehicle 10 and/or a voice of a second occupant of the vehicle 10.

Additionally or alternatively, depending on the camera 13, the first personal information (EPI) and/or the second personal information (ZPI) and/or the first request information and/or the second request information and/or the first user input (ENI) and/or the second user input (ZNI) can be captured, for example depending on an image captured by the camera 13. For example, depending on the camera 13, gesture recognition can be performed and used to capture the corresponding information.

Depending on the output device 14, the first occupant and/or the second occupant can be provided with first proposal information (EVI) and/or second proposal information (ZVI).

For example, the output device 14 comprises a touch-sensitive display device (so-called “touch display”) of the vehicle 10 and/or a loudspeaker of the vehicle 10 or similar.

For example, the vehicle 10 may also comprise a plurality of input devices 11 and/or a plurality of microphones 12 and/or a plurality of cameras 13 and/or a plurality of output devices 14, which may be arranged at a plurality of different positions in the vehicle 10. For example, one of the plurality of microphones 12 is fitted on each seat of the vehicle 10.

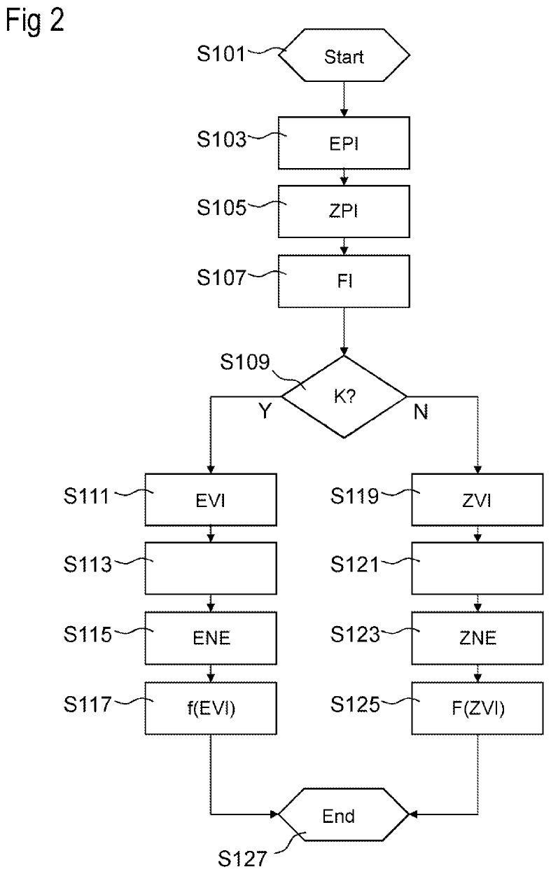

FIG. 2 shows a flowchart of a program for operating a vehicle.

In particular, the program can be executed by a device. For this purpose, the device has in particular a computing unit, a program and data memory, and, for example, one or more communication interfaces. The program and data memory and/or the computing unit and/or the communication interfaces can be implemented in one component and/or distributed over multiple components.

For example, the device can be referred to as device 17 for operating the vehicle 10.

In particular, the program is stored on the program and data memory of the device for this purpose.

The program is launched in a step S101, in which variables can be initialized if necessary.

The program is continued in a step S103. In step S103 first personal information (EPI) is captured. The first personal information (EPI) is representative of a first occupant of the vehicle 10.

Optionally, in step S103, the first personal information (EPI) includes first personal prioritization information. The first personal prioritization information is representative of a prioritization of the first occupant.

In step S103, the first personal information (EPI) is optionally representative of a first spatial assignment of the first occupant within the vehicle 10.

Optionally, in step S103, the first personal information (EPI) includes a first user history of the first occupant.

According to a first example, the first personal information (EPI) is representative of a driver of the vehicle 10, who is seated in a driver's seat of the vehicle 10 and who is prioritized over a child.

According to the second example, the first personal information (EPI) is representative of a chauffeur, who is also the driver of the vehicle 10 and seated in the driver's seat of the vehicle 10.

Directly following step S103, the program is continued in a step S105. In step S105, second personal information (ZPI) is captured. The second personal information (ZPI) is representative of a second occupant of the vehicle 10.

Optionally, in step S105, the second personal information (ZPI) includes second personal prioritization information. The second personal prioritization information is representative of a prioritization of the second occupant.

In step S105, the second personal information (ZPI) is optionally representative of a second spatial assignment of the second occupant within the vehicle 10.

Optionally, in step S105 the second personal information (ZPI) includes second user history of the second occupant.

According to the first example, the second personal information (ZPI) is representative of the child seated in a front passenger seat of the vehicle 10.

According to a second example, the second passenger information (ZPI) is representative of a passenger seated in a rear seat of vehicle 10 and who is prioritized over a chauffeur.

Directly following step S105, the program is continued in a step S107. Vehicle information (FI) is provided in step S107. The vehicle information (FI) is representative of a specified set of vehicle functions and dependencies between the vehicle functions that exist when they are executed.

According to the first example, the set of vehicle functions comprises a vehicle function designed to play a music request depending on the loudspeaker.

According to the second example, the specified set of vehicle functions comprises a vehicle function that is designed to set a temperature depending on an air conditioning system of the vehicle 10 and/or on a heating system of the vehicle 10 in an interior of the vehicle 10. According to the second example, the rear seat is designed in such a way that it has a device for massaging an occupant. In addition, the specified set of vehicle functions comprises an additional vehicle function which is designed to control a massage device. In addition, the vehicle information (FI) is representative of the fact that a vehicle type of the vehicle 10 is a saloon.

Directly following step S107, the program is continued in a step S109. In step S109, if first request information, which is representative of a first request by the first occupant for a first vehicle function from the predefined set of vehicle functions, and second request information, which is representative of a second request by the second occupant for a second vehicle function from the predefined set of vehicle functions, are captured, the vehicle information (FI), the first request information and the second request information are used as a basis for ascertaining whether the first request for the first vehicle function and the second request for the second vehicle function show a correlation (K), such that a prioritization should take place with regard to execution of the first vehicle function and execution of the second vehicle function. If such a correlation (K) exists, the program is continued in step S111. If no such correlation (K) exists, the program is continued in an optional step S119.

According to the first example, the first request information is representative of the driver wanting to play a first music request, which is representative of a first artist, at a first time point.

According to the first example, the second request information is representative of the child wanting to play a second music request, which is representative of a song by a second artist, at a first time point. The second time point is essentially immediately after the first time point. In this context, the term “immediately” means, for example, a few seconds, for example in a range below one minute.

According to the first example, such a correlation (K) is identified because the vehicle function is designed to play only one music request at a time.

According to the second example, the first request information is representative of the chauffeur wanting to set a first temperature in the vehicle 10 at a fifth time point.

According to the second example, the second request information is representative of the passenger wanting to set a second temperature in the vehicle 10 at a sixth time point. The sixth time point is located after the fifth time point. At the sixth time point, the temperature inside the vehicle 10 corresponds to the first temperature. Furthermore, the second request information is representative of the passenger wanting to activate the massage device with a preset massage setting at the sixth time point.

According to the second example, no such correlation (K) is identified, as the other vehicle function is designed to use the air conditioning system to adjust the first temperature in a first region of the interior in which the driver's seat is arranged, and to adjust the second temperature in a second region of the interior where the rear seat is arranged. For example, depending on the first temperature and the second temperature, a temperature difference is determined that does not exceed a specified threshold value. Furthermore, no such correlation (K) is identified, as the execution of the other vehicle function has no dependency on the execution of the vehicle function.

In step S111, first proposal information (EVI) is ascertained depending on the first personal information (EPI) and the second personal information (ZPI). The first proposal information (EVI) is representative of the way in which the priority should be given with regard to the execution of the first vehicle function and the execution of the second vehicle function.

According to the first example, the first proposal information (EVI) is representative of the first music request being played first, followed by the second music request.

Directly following step S111, the program is continued in an optional step S113. In the optional step S113, the first proposal information (EVI) is provided to the first occupant and/or the second occupant.

According to the first example, the vehicle 10 comprises a digital voice assistant which is designed to interact with the first occupant and the second occupant depending on the input device 11 and/or the output device 14. The first proposal information (EVI) is provided to the driver and the child depending on the digital voice assistant and the output device 14.

Directly following the optional step S113, the program is continued in an optional step S115. In the optional step S115, a first user input (ENI) by the first occupant and/or the second occupant is captured.

According to the first example, depending on the input device 11, the first user input (ENI) by the driver is captured, wherein the first user input (ENI) is representative of the driver agreeing to the procedure according to the first proposal information (EVI).

Directly following the optional step S115, the program is continued in a step S117. In step S117, the first vehicle function and/or the second vehicle function is or are executed for operating the vehicle 10 depending on the first proposal information (EVI). Optionally, in step S117 the first vehicle function and/or the second vehicle function is or are executed for operating the vehicle 10 depending on the first user input (ENI).

Optionally, in step S117 the first vehicle function and/or the second vehicle function is or are executed for operating the vehicle 10 depending on the first personal information (EPI) and/or the second personal information (ZPI).

According to the first example, the first music request is played first, followed by the second music request.

Directly after step S117, the program is terminated in step S127 and can be started again in step S101 or in step S109 if required.

In the optional step S119, second proposal information (ZVI) is ascertained depending on the first personal information (EPI) and the second personal information (ZPI). The second proposal information (ZVI) is representative of the way in which the first vehicle function and the second vehicle function should be executed.

According to the second example, the second proposal information (ZVI) is representative of the second temperature being adjusted in the second region of the interior and the massage device being activated according to the preset massage setting.

Directly following the optional step S119, the program is continued in an optional step S121. In the optional step S121, the second proposal information (ZVI) is provided to the first occupant and/or the second occupant.

Directly following the optional step S121, the program is continued in an optional step S123. In the optional step S123, a second user input (ZNI) by the first occupant and/or the second occupant is captured.

Directly following the optional step S123, the program is continued in an optional step S125. In the optional step S125, the first vehicle function and the second vehicle function are executed for operating the vehicle 10 depending on the second proposal information (ZVI).

Optionally, in the optional step S125 the first vehicle function and the second vehicle function are executed for operating the vehicle 10 depending on the second user input (ZNI).

Directly after the optional step S125, the program is terminated in step S127 and can be started again in step S101 or step S109 if required.

According to the first example, after playing the second music request, the first music request is played again. A further second request information item can be captured, which is representative of the fact that the child would like to play the second music request at a third time point. A further first proposal information item (EVI) can be ascertained that is representative of playing the second music request. The further first proposal information (EVI) can be provided to the driver and the child, depending on the digital voice assistant and the output device 14. Depending on the input device 11, a further first user input (ENI) by the driver can be captured, wherein the further first user input (ENI) can be representative of the fact that the driver does not agree to the procedure according to the first proposal information (EVI). In this case, the first music request can continue to be played.

According to the second example, the second temperature is automatically set in the second region of the interior and the massage device is automatically activated according to the preset massage setting. A further first request information item can be captured, which is representative of the chauffeur wishing to play a third music request, representative of a radio program, at a seventh time point. A further second request information can be captured, which is representative of the passenger wanting to play a fourth music request, representative of a media file (so-called “podcast”), at an eighth time point. The eighth time point is located after the seventh time point. At the eighth time point the temperature will correspond to the third music request being played. For example, such a correlation (K) can be identified if only one music request can be played simultaneously. A first proposal information item (EVI) can be ascertained that is representative of playing the fourth music request. In this case, the third music request can be stopped and the fourth music request can be played automatically.

Elements of the same design or function are identified with the same reference signs across all figures.

For example, the program can be repeated as desired.

1.-10. (canceled)

11. A method for operating a vehicle, comprising:
capturing first personal information which is representative of a first occupant of the vehicle,
capturing second personal information which is representative of a second occupant of the vehicle,
providing vehicle information which is representative of a predefined set of vehicle functions and dependencies between the vehicle functions that exist when they are executed,
if first request information, which is representative of a first request by the first occupant for a first vehicle function from the predefined set of vehicle functions, and second request information, which is representative of a second request by the second occupant for a second vehicle function from the predefined set of vehicle functions, are captured,
then ascertaining, based at least in part on the vehicle information, the first request information and the second request information, whether the first request for the first vehicle function and the second request for the second vehicle function have a correlation such that prioritization should take place with regard to execution of the first vehicle function and execution of the second vehicle function,
if it is ascertained that the correlation exists,
then ascertaining, based at least in part on the first personal information and the second personal information, first proposal information, which is representative of a way in which the priority is to be given with regard to the execution of the first vehicle function and the execution of the second vehicle function, and executing the first vehicle function and/or the second vehicle function for operating the vehicle depending on the first proposal information.

12. The method as claimed in claim 11, wherein the first personal information comprises first personal prioritization information which is representative of a prioritization of the first occupant, and/or the second personal information comprises second personal prioritization information which is representative of a prioritization of the second occupant.

13. The method as claimed in claim 12, wherein:
the first proposal information is provided to the first occupant and/or the second occupant,
a first user input by the first occupant and/or second occupant is captured, and
the first vehicle function and/or the second vehicle function is or are executed for operating the vehicle depending on the first user input.

14. The method as claimed in claim 13, wherein executing the first vehicle function and/or the second vehicle function for operating the vehicle further comprises executing the first vehicle function and/or the second vehicle function depending on the first personal information and/or the second personal information.

15. The method as claimed in claim 12, wherein:
the first personal information is representative of a first physical assignment of the first occupant within the vehicle, and/or
the first personal information comprises a first user history of the first occupant, and/or
the second personal information is representative of a second physical assignment of the second occupant within the vehicle, and/or
the second passenger information comprises a second user history of the second occupant.

16. The method as claimed in claim 11, wherein:
the first proposal information is provided to the first occupant and/or the second occupant,
a first user input by the first occupant and/or second occupant is captured, and
the first vehicle function and/or the second vehicle function is or are executed for operating the vehicle depending on the first user input.

17. The method as claimed in claim 16, wherein executing the first vehicle function and/or the second vehicle function for operating the vehicle further comprises executing the first vehicle function and/or the second vehicle function depending on the first personal information and/or the second personal information.

18. The method as claimed in claim 11, wherein:
the first personal information is representative of a first physical assignment of the first occupant within the vehicle, and/or
the first personal information comprises a first user history of the first occupant, and/or
the second personal information is representative of a second physical assignment of the second occupant within the vehicle, and/or
the second passenger information comprises a second user history of the second occupant.

19. The method as claimed in claim 11, wherein:
if it is not ascertained that the correlation exists, then ascertaining, based at least in part on the first personal information and the second personal information, a second proposal information, which is representative of a way in which the first vehicle function and the second vehicle function should be executed, and executing the first vehicle function and the second vehicle function for operating the vehicle depending on the second proposal information.

20. The method as claimed in claim 19, wherein:
the second proposal information is provided to the first occupant and/or the second occupant,
a second user input by the first occupant and/or the second occupant is captured, and
the first vehicle function and the second vehicle function are executed for operating the vehicle depending on the second user input.

21. A device for operating a vehicle, which is configured to carry out the method as claimed in claim 11.

22. The device as claimed in claim 21, wherein the device is further configured such that:
the first personal information comprises first personal prioritization information which is representative of a prioritization of the first occupant; and/or
the second personal information comprises second personal prioritization information which is representative of a prioritization of the second occupant.

23. The device as claimed in claim 21, wherein the device is further configured such that:
the first proposal information is provided to the first occupant and/or the second occupant,
a first user input by the first occupant and/or second occupant is captured, and
the first vehicle function and/or the second vehicle function is or are executed for operating the vehicle depending on the first user input.

24. A computer program, wherein the computer program comprises instructions, which, when the program is executed by a computer, cause the computer to carry out the method as claimed in claim 11.

25. The computer program as claimed in claim 24, wherein the instructions further cause the computer to carry out the method wherein:
the first personal information comprises first personal prioritization information which is representative of a prioritization of the first occupant; and/or
the second personal information comprises second personal prioritization information which is representative of a prioritization of the second occupant.

26. The computer program as claimed in claim 24, wherein the instructions further cause the computer to carry out the method wherein:
the first proposal information is provided to the first occupant and/or the second occupant,
a first user input by the first occupant and/or second occupant is captured, and
the first vehicle function and/or the second vehicle function is or are executed for operating the vehicle depending on the first user input.

27. A machine-readable storage medium, on which the computer program as claimed in claim 24 is stored.
